(19) United States
(12) Patent Application Publication
(10) Pub. No.: US 2013/0100983 A1
(43) Pub. Date: Apr. 25, 2013

(54) Time and temperature duration indicator for eradicating pests and method of use

(71) Applicant: Russell Meldrum, Zionsville, IN (US)

(72) Inventor: Russell Meldrum, Zionsville, IN (US)

(21) Appl. No.: 13/317,594

(22) Filed: Oct. 24, 2011

(51) Int. Cl. G01K 3/00

(52) U.S. Cl. 374/102; 374/E03.001

(57) ABSTRACT

A time and temperature duration indicator facilitates eradicating of pests. The invention contemplates a temperature sensor including a material that changes color when the desired temperature is achieved. The color change allows one to view a colored spot. A wax may be employed that melts at the desired temperature and provided in sufficient quantity that complete melting indicates the desired temperature and duration have been achieved. In another embodiment, a temperature sensor sends a signal to a computer/timer. When the signal indicates that the desired temperature has been achieved, the computer starts a timer. When the timer indicates to the computer that the desired temperature has been maintained for the desired time interval, the computer activates an indicator. Several embodiments are contemplated for holding the inventive device at a desired location. Methods of operation are also disclosed.

### BACKGROUND OF THE INVENTION

The present invention relates to a time and temperature duration indicator for eradicating pests and its method of use. Bed bug infestation of hotels and other facilities has risen to epidemic proportions. Some of the most prestigious hotels in New York City have reported bed bug infestations and their customers have departed those hotels with numerous bed bug bites. Bed bugs exist in several stages of life including eggs, larvae, and adults. Bed bugs are a parasite that feeds on the blood of their host, typically a human being sleeping in a bed. Bed bugs are quite hardy and can live up to a year without a meal. Typically, their bite is undetected by a sleeping person and is only evidenced by a small red dot visible on the skin evidencing blood clotting once the bed bug has completed their blood meal.

Bed bugs do not typically transmit diseases but it is quite unsettling for a person to wake up in the morning and discover they have been sharing their bed with a small insect that was feeding on their blood.

In Practical Solutions for Treating Laundry Infested With Cimex lectularius (Hemiptera: Cimicidae) by R. A. Naylor and C. J. Boase, © 2010 Entomological Society of America, the authors discuss a variety of methods for eradicating bed bugs. These methods include use of insecticides as well as freezing and heating. The authors conclude that washing bed bug infested laundry at 60° C. achieves total mortality in all bed bug life stages, but that a 40° C. wash was sufficient only to kill active stages but not bed bug eggs.

The authors further concluded that using a laundry dryer is effective to kill all life stages of bed bugs where the dryer temperature exceeded 40-45° C. for at least 30 minutes. The authors also found that freezing the laundry at −17° C. for at least two hours killed 100% of all life stages and that dry cleaning with perchloroethylene resulted in 100% mortality of all life stages. However, cold soaking laundry for 24 hours was sufficient to kill the active stages, but had no effect on survival of bed bug eggs.

Taking all of these options into consideration, it appears that the easiest and most effective way to eradicate all life stages of bed bugs is to expose them to the heat of a clothes dryer at a temperature above 45° C. and for a time period of at least 30 minutes. The question is, how does one assure that the requisite temperature has been achieved and has been maintained for the requisite time period? The present invention intends to answer this question.

In addition, the teachings of the present invention may equally be applied to eradication of lice, although higher temperatures are required.

The following prior art is known to Applicant:

U.S. Pat. No. 3,733,905 to Bremer; U.S. Pat. No. 3,951,133 to Reese; U.S. Pat. No. 5,340,537 to Barrett; and U.S. Pat. No. 5,622,137 to Lupton, Jr. et al., as well as Published Application Nos. US 2006/0121229 A1 to Nagae and US 2009/0046760 A1 to Matheson all disclose chemically based thermometer devices in which temperature sensing chemicals are employed which can change color responsive to desired temperatures being achieved. None of these patents teaches or suggests using such a device to ensure that a threshold temperature has been reached facilitating eradication of bed bugs.

U.S. Published Patent Application Nos. US 2010/0120652 A1 to Corrado and US 2010/0166818 A1 to Troutman disclose the use of pesticides in laundering clothing to eradicate bed bugs. The present invention differs from the teachings of these Published Applications as contemplating an apparatus and method for eradicating bed bugs in all of their life stages by exposing them to a threshold temperature for a desired time period without use of pesticides.

### SUMMARY OF THE INVENTION

The present invention relates to a time and temperature duration indicator for eradicating pests and its method of use. The present invention includes the following interrelated objects, aspects and features:

(1) In a first aspect, the present invention contemplates a temperature sensor that includes a thermochromic material that changes color when the desired temperature is achieved. The color change is to a translucent color that allows one to view a material behind the thermochromic material. Additionally, a wax may be employed that melts at the desired temperature evidencing that the desired temperature has been achieved, and is provided in sufficient quantity that complete melting indicates that the desired temperature has been achieved for the desired duration.

(2) As noted above, it is important to know that the desired temperature, typically 120° F. or approximately 49° C. for bed bugs or 156° F. (69° C.) for lice has been achieved and maintained for the desired time period. For this reason, in the case of bed bugs, Applicant has found that approximately 0.1 grams of a paraffin wax elevated to a temperature of 120° F. melts over a period of 20 minutes. In the case of lice, 0.17-0.22 grams of another paraffin wax elevated to a temperature of 156° F. melts over a period of 20 minutes. Thus, by choosing the desired type and quantity of wax, one may determine whether the desired elevated temperature has been maintained for the desired time period.

(3) In a further aspect, another means is contemplated in accordance with the teachings of the present invention. In particular, a temperature sensor of any kind sends a signal to a computer/timer. When the signal indicates that the desired temperature, for example, 120° F., has been achieved, the computer starts a timer mechanism. When the timer mechanism indicates to the computer that the desired temperature has been maintained for the desired time interval, the computer activates an indicator that so indicates. If at any time during the period being timed, the temperature sensor indicates that the temperature has dropped below the threshold temperature, the computer will stop and zero the timer and then re-start the timer once the temperature has regained at least the threshold temperature.

(4) Several embodiments are contemplated for holding the inventive device at a desired location to perform its functions. Thus, one option is to provide a suction cup or other attachment means that affixes the indicator on the inside of the door of a clothes dryer. Another option is to provide a container in which the temperature sensor is contained and which is placed within the basket of the clothes dryer, but the container separates the sensor from the wet clothing. A further option is to use any desired adhesive to adhere the temperature sensor to an inside wall of the clothes dryer.

(5) Where the embodiment is employed in which a computer is utilized, the connection between the temperature sensor and the computer may, if desired, be wireless via a transmitter/receiver sub-system.

Accordingly, it is a first object of the present invention to provide a time and temperature duration indicator for eradicating bed bugs or lice and method of use.

It is a further object of the present invention to provide such a device in which in one embodiment thereof a chemical temperature indicator is employed.

It is a yet further object of the present invention to provide such a device in which a temperature sensor is employed that sends signals indicating temperature to a computer/timer.

It is a further object of the present invention to provide such a system in which a temperature sensor is contained within a basket placed within a clothes dryer.

It is a still further object of the present invention to provide such a system in which a suction cup or other attachment means is used to attach the temperature sensor on the door of a clothes dryer inside its basket.

These and other objects, aspects and features of the present invention will be better understood from the following detailed description of the preferred embodiments when read in conjunction with the appended drawing figures.

### BRIEF DESCRIPTION OF THE DRAWINGS

FIG. 1 shows a perspective view of a first embodiment of time temperature indicator.

FIG. 2 shows a front view of the time temperature indicator of FIG. 1 before indicating the desired temperature for the desired time interval.

FIG. 3 shows a view similar to that of FIG. 2 but showing the indication of the time temperature interval desired.

FIG. 4 shows the second embodiment of the present invention in which a fenestrated ball has a chamber accessible via a slot in which may be inserted a time temperature indicator.

FIG. 5 shows a further view of the device of FIG. 4.

FIG. 6 shows an alternative construction of the embodiment of FIGS. 4 and 5 in which a door is provided to which is releasably affixed the time temperature indicator.

FIG. 7 shows a further view of the modification of FIG. 6.

FIG. 8 shows a rectangular cubic box having a plurality of fenestrations and including a pivotable door allowing access to its internal chamber to place and remove a time temperature indicator.

FIG. 9 shows an alternative embodiment.

### SPECIFIC DESCRIPTION OF THE PREFERRED EMBODIMENTS

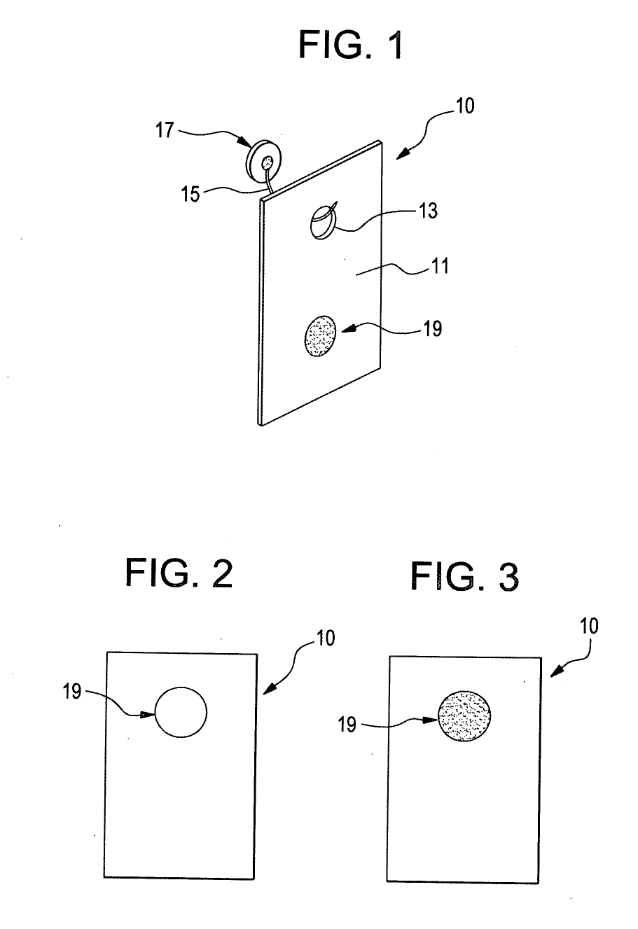

FIG. 1 shows a first example of a time temperature indicator in accordance with the teachings of the present invention designated by the reference numeral 10, and including a rectangular base or substrate 11 with attachment means comprising an opening 13 sized to attach at a desired location such as receiving the end of a hook 15 affixed to a fastener 17 which can comprise a suction cup or one-half of a hook and pile fastening means such as known by the registered trademark VELCRO. Suction cup 17 or other attachment means may be used to affix the indicator 10 within the door (not shown) of the dryer (not shown). Where the dryer door has a transparent window, this enables the user to view the indicator 10 from outside the dryer. The base 11 includes a spot 19 thereon which consists of a quantity of a temperature sensing chemical which turns color when exposed to a temperature above a predetermined threshold. The base or substrate 11 can be made of cardboard, plastic or metal.

In an alternative embodiment, the spot 19 may consist of a layer of a wax covering a colored spot underneath. The quantity of wax chosen is such that when it is exposed to a desired temperature for a desired duration of time, the wax melts completely away exposing the colored spot. In one example, a first paraffin wax that melts at 120° F., provided in a quantity of 0.1 grams will melt completely approximately 20 minutes. As such, such a quantity of wax covering a colored spot will melt away if exposed to a temperature of 120° F. for a period of at least 20 minutes, thereby exposing the colored spot and indicating to a viewer that the device 10 has been exposed to a temperature of 120° F. for a period of at least 20 minutes. One of ordinary skill in the art can easily, from this information, determine the quantity of wax required so that at a particular temperature and a particular duration, the quantity melts away revealing an indicator underneath. As another example, 0.17-0.22 grams of another type of paraffin wax melts completely away at a temperature of 156° F. for a duration of 20 minutes. These paraffin waxes are easily obtainable from Swans Candles LLP of Lakewood, Wash.

FIG. 2 shows the device 10 with the spot 19 before the elevated temperature has caused a change and FIG. 3 shows the spot 19 after a temperature change has taken place, either to cause a thermochromic chemical to change color or for a wax to melt away revealing a colored spot underneath.

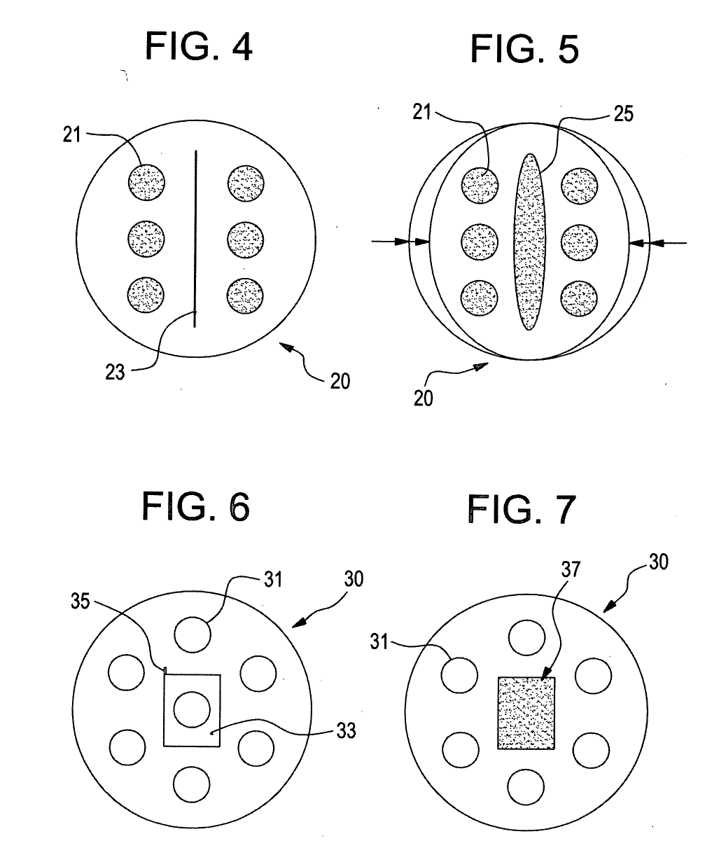

With reference to FIGS. 4 and 5, a second embodiment of the present invention is designated by the reference numeral 20 and is seen to comprise a container comprising a hollow ball having a plurality of openings 21 that cause it to be fenestrated. A slot 23 (FIG. 4) or a wider opening 25 (FIG. 5) allows insertion of a device such as the device 10 illustrated in FIGS. 1-3. The ball 20 may be placed in the drum of a dryer in the midst of clothing with the surface of the ball 20 protecting the indicator from the wetness of the clothing, and with the holes 21 allowing transmission of heat within the ball 20 so that the indicator 10 can receive that heat which causes changes to occur, such as illustrated in FIGS. 2 and 3, and explained hereinabove.

The container embodiment of FIGS. 6 and 7 is generally designated by the reference numeral 30 and includes holes 31 so that the ball 30 is fenestrated. The ball 30 has a door 33 mounted on a pivot 35 that in the opened position exposes an internal chamber 37 into which an indicator such as the indicator 10 may be placed, whereupon the door 33 may be closed and the ball 30 may be inserted into the drum of a dryer so that heat from the dryer penetrates through the holes 31 and causes changes to occur in the indicator 10 such as illustrated in FIGS. 2 and 3.

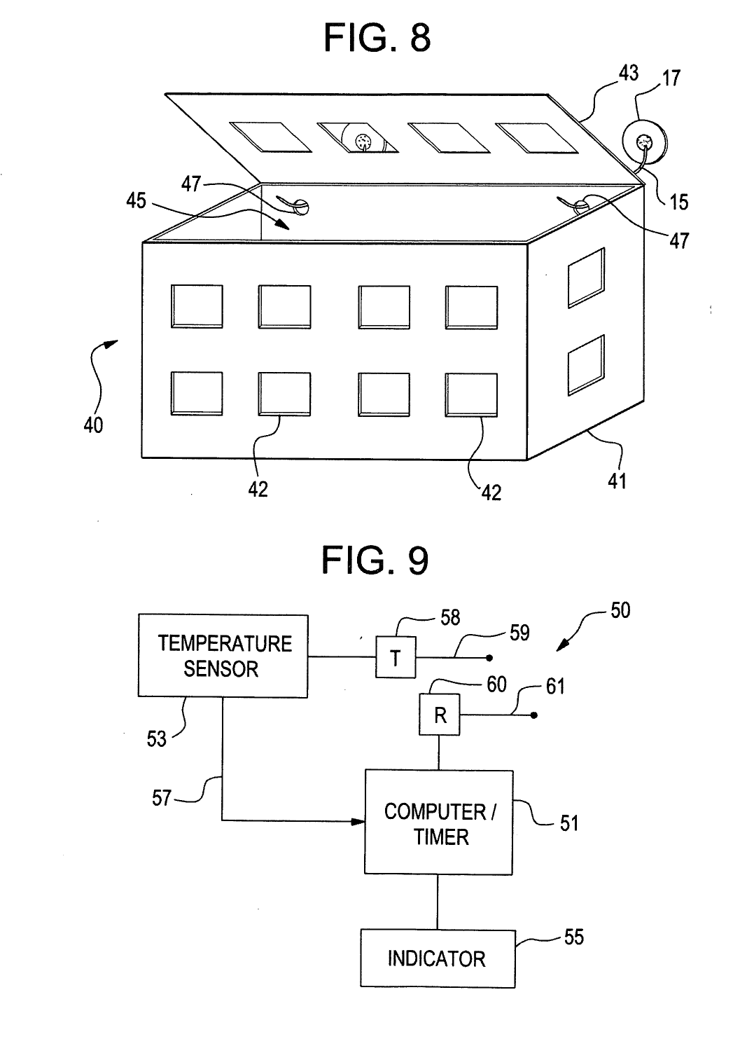

Reference is now made to FIG. 8 which shows a further embodiment of the present invention generally designated by the reference numeral 40. In this embodiment, a container comprises a rectangular cubic box including a body 41, a lid 43 hingedly mounted to the body 41, and when open allowing access to an internal chamber 45 in which an indicator such as the indicator 10 may be placed. The box 40 may include a plurality of holes 47 intended to receive hooks 15 and attachment means 17 such as described with reference to FIG. 1, namely, suction cups, hook and pile fastening means or any other desired fastener. The box 40 is fenestrated by virtue of having a plurality of holes 42 therethrough which permit heat from within the drum of a dryer to penetrate into the chamber 45 and expose the indicator 10 to the temperature within the drum.

With reference to FIG. 9, a further embodiment of the present invention is generally designated by the reference numeral 50 and is seen to include a computer/timer 51, a temperature sensor 53, and an indicator 55. The temperature sensor 53 may be interconnected with the computer/timer 51 by a wired connection 57 or a wireless connection relying upon a transmitter 58 with an antenna 59, and a receiver 60 with an antenna 61. The transmitter 58 is connected to the temperature sensor 53 and the receiver 60 is connected to the computer/timer 51.

In operation of the embodiment of FIG. 9, the temperature sensor 53 is located within the drum of a clothes dryer. It can be mounted as shown in FIG. 1, or contained within a ball such as illustrated in FIGS. 4-7, or within a box such as illustrated in FIG. 8. When the temperature sensor 53 senses temperatures, signals corresponding to those temperatures are transmitted to the computer/timer either by the wired connection 57 or via the transmitter 58 and receiver 60. Once the temperature sensed by the temperature sensor 53 exceeds a pre-set threshold, the computer/timer 51 activates its timer and begins timing the time period within which the sensed temperature is above the pre-set threshold. If the duration of time in which the temperature sensed is ever greater than the pre-set threshold, at the conclusion of that time period, the computer/timer 51 sends a signal to the indicator 55 activating the indicator which can be audible, visual, or a combination audible/visual indication. If, during a period in which the timer is activated, the temperature sensed by the temperature sensor 53 drops below the pre-set threshold, the computer/timer stops the timer and re-sets it to zero so that it can re-start once the temperature sensed by the temperature sensor 53 rises above the pre-set threshold.

Applicant has found that in order to exterminate all stages of bed bug life, the clothing and bedding within the clothes dryer must be exposed to a temperature of at least 120° F. for a time duration of at least 20 minutes. For lice, a higher temperature such as 156° for a similar time period must be achieved.

As explained above, Applicant has experimented with what quantity of a particular wax with a melting point of 120° F. must be employed so that the entirety of the wax is melted away within a desired time period such as, for example, 20 minutes. In conducting experiments, Applicant discovered that 0.1 grams of 120° F. melting point paraffin wax completely melts over an elapsed time of 20 minutes at 120° F. Applicant has examined typical U.S. clothes dryers and has concluded that in a 20 minute timed drying cycle, the drum achieved the temperature of 160° F. on the high setting, 130° F. on the medium setting, 120° F. on the low setting, and 110° F. on the very low setting. When the cycle was instead increased to 40 minutes, the temperatures were: High—170° F.; Medium—140° F.; Low—130° F.; and Very Low—120° F.

As should be understood, the heat capacitance of any material measures its change in temperature as energy applied. Thus, it is possible to determine the amount of energy that must be applied to, for example, a wax, to start it melting and complete a melting process. As explained above, to kill lice, a higher temperature must be achieved, at least 156° F. for a period of 20 minutes. In that case, another formulation of a paraffin wax having a melting point of 156° F. is employed.

In the method of practicing the present invention, one must first provide a temperature indicator that also provides for knowledge concerning the time duration at which the temperature has been continuously elevated above a desired threshold. Such an indicator is mounted within an area where heat is to be applied such as, for example, the drum of a clothes dryer. Clothing and perhaps bedding are placed within the drum and the dryer is activated at a temperature setting that will result in elevation of the temperature of the dryer to a level above the threshold needed to kill all stages of a bed bug (120° F.) for 20 minutes, or lice (156° F.) for 20 minutes. The drying cycle is completed and if the indicator indicates that the threshold pre-set temperature has been achieved for the desired time period, the user can be assured that the bed bugs or lice or both have been eradicated in all of their stages of life from eggs to larvae, to adults. In this way, the user can be assured that these pests have been eradicated.

As such, an invention has been disclosed in terms of preferred embodiments thereof which fulfill each and every one of the objects of the present invention as set forth hereinabove, and provide a new and useful time and temperature duration indicator for eradicating pests as well as lice, and the method of practicing the invention of great novelty and utility.

Of course, various changes, modifications and alterations in the present invention may be contemplated by those of ordinary skill in the art without departing from the intended spirit and scope thereof.

As such, it is intended that the present invention only be limited by the terms of the appended claims.

1. A time and temperature indicator, comprising:
a) a substrate;
b) a quantity of a temperature sensitive material on said substrate, said quantity being chosen such that when said material is exposed to at least a threshold temperature for at least a chosen duration, said material indicates said temperature has been achieved for said duration;
c) said substrate and material being located in a location where it is desired to measure said temperature for said duration.

2. The indicator of claim 1, wherein said substrate is made of a material chosen from the group consisting of cardboard, plastic and metal.

3. The indicator of claim 2, wherein said substrate includes attachment means for attaching said substrate to a desired location.

4. The indicator of claim 3, wherein said desired location comprises a hook.

5. The indicator of claim 4, wherein said hook is attached within a chamber of a dryer.

6. The indicator of claim 2, wherein said substrate is contained within a container.

7. The indicator of claim 6, wherein said container comprises a ball.

8. The indicator of claim 6, wherein said container is rectangular cubic.

9. The indicator of claim 6, wherein said container has fenestrated walls.

10. The indicator of claim 1, wherein said material comprises a thermochromic material.

11. The indicator of claim 1, wherein said material comprises a quantity of wax.

12. The indicator of claim 11, wherein said wax is located over a colored spot on said substrate.

13. The indicator of claim 11, wherein said wax has a melting point of about 120° F.

14. The indicator of claim 11, wherein said wax has a melting point of about 156° F.

15. The indicator of claim 13, wherein said wax completely melts in about 20 minutes.

16. The indicator of claim 14, wherein said wax completely melts in about 20 minutes.

17. A method of determining that an area has been elevated to a desired temperature for a desired time duration including the steps of:
a) providing a time and temperature indicator, comprising:
i) a computer/timer;
ii) a temperature sensor connected to said computer/timer and sending signals to said computer/timer indicative of a temperature sensed by said temperature sensor; and
iii) an indicator connected to said computer/timer;
b) placing said temperature sensor in a location where temperature is to be monitored;
c) said computer/timer receiving signals from said temperature sensor indicative of a temperature;
d) when said temperature is at a desired level, activating said timer for a desired time period;
e) said computer/timer activating said indicator when said temperature sensor has sensed a desired temperature for a desired time period.

18. The method of claim 17, wherein said temperature sensor is connected to said computer/timer with a wireless connection.

19. The method of claim 17, wherein after said activating step, if said temperature reduces below said desired temperature prior to said desired time period being achieved, further including the step of stopping and resetting said timer and restarting said timer when said temperature again achieves said desired temperature.

20. The method of claim 17, further including the step of locating said temperature sensor within a clothes dryer.
